(19) United States
(12) Patent Application Publication
(10) Pub. No.: US 2008/0050067 A1
(43) Pub. Date: Feb. 28, 2008

(54) Optical gate array device

(75) Inventor: Goji Nakagawa, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/640,232

(22) Filed: Dec. 18, 2006

(30) Foreign Application Priority Data
Aug. 23, 2006 (JP) JP 2006-226552

(51) Int. Cl. G02B 6/32

(52) U.S. Cl. 385/33

(57) ABSTRACT

An optical gate array device which permits the use of an optical gate array with a pitch smaller than the diameter of optical fibers. The optical gate array has an array of optical gates, and an optical fiber array has an array of optical fibers. A lens is arranged between the optical gate array and the optical fiber array, for collectively achieving optical coupling between all of the optical gates of the optical gate array and all of the optical fibers of the optical fiber array.

### CROSS-REFERENCE TO RELATED APPLICATIONS

This application is based upon and claims the benefits of priority from the prior Japanese Patent Application No. 2006-226552, filed on Aug. 23, 2006, the entire contents of which are incorporated herein by reference.

### BACKGROUND OF THE INVENTION

1. Field of the Invention

The present invention relates to optical gate array devices, and more particularly, to an optical gate array device having an array of optical gates for controlling optical signals.

2. Description of the Related Art

With the recent increasing demand for broadband communication services, optical communication networks have become capable of carrying a large volume of data over long distances, and the development of high-speed large-capacity WDM (Wavelength Division Multiplex: wavelength division multiplexing technique for multiplexing different wavelengths of light to simultaneously transmit multiple signals over a single optical fiber) has been actively pursued.

Also, because of the rapid diffusion of the Internet and an increase in large-capacity content, optical communication networks capable of higher-speed, larger-capacity data transmission and having flexibility are demanded. In the circumstances, optical packet switching is attracting attention as a technology for configuring such optical communication networks.

With the optical packet switching technology, communication information is switched directly in the form of optical packets. Compared with conventional switching techniques in which optical signals are once converted to electrical signals, no restriction is imposed by the electronic processing speed, and since optical signals can be processed at a rate equivalent to the light propagation delay time, high-speed, large-capacity transmission can be achieved.

In the case of switching an optical signal on a packet-by-packet basis, a gate switch is used to switch the optical signal ON and OFF. There are two major types of gate switch for switching optical signals ON and OFF through electric control, namely, the type adapted to vary the absorption of light by utilizing an electro-absorption effect, and the type adapted to vary the gain of a semiconductor amplifier by means of a driving current supplied thereto.

An electro-absorption type gate switch has a drawback in that the loss is high even in the state of transmission. On the other hand, a semiconductor optical amplifier (SOA), which is a switch adapted to vary its gain by means of the driving current supplied thereto, not only functions as an optical gate for switching light ON and OFF but also has an amplifying function (when the gate is ON, light amplified thereby is output). Thus, SOA is currently watched as an optical device capable of high-speed switching with low loss of optical signal.

Further, SOA has a large extinction ratio between gate ON (open) and OFF (closed) states and is also capable of reducing optical loss by means of its amplifying mechanism. Moreover, since SOA is an optical device made of semiconductor, small-sized SOA can be fabricated at low cost by using semiconductor integration technology.

FIG. 12 shows a conventional arrangement for optical coupling between an SOA and an optical fiber. If light pumped inside the chip of an SOA 51 is reflected at its end face, unwanted oscillation is caused by the reflected light, deteriorating the characteristics of the SOA. It is therefore necessary that the end face of the SOA should have a low reflectance of −50 dB or less.

Accordingly, the end face of the SOA 51 is coated with an AR (Anti Reflection) coating (not shown), which is a non-reflective film. However, the AR coating alone is unable to satisfactorily reduce the return loss, and therefore, the SOA 51 is obliquely positioned such that the normal H perpendicular to the end face of the SOA 51 and an optical waveguide L within the SOA 51 form an angle of, for example, 7°.

Since the SOA 51 is positioned in this manner, light from an optical fiber 52a obliquely passes through the SOA 51 along the optical waveguide L toward an optical fiber 52b, and the light reflected at the end face of the chip propagates in a direction A shown in the figure (at an angle of 14° with respect to the optical waveguide L). Thus, the reflected light is prevented from returning back through the optical waveguide L, and therefore, does not interfere with the incoming light.

Let it be assumed that the refractive index of the light incidence-side medium is nl, that the incidence angle is θ₁, that the refractive index of the light emergence-side medium is n₂, and that the emergence angle is θ₂. From Snell's law, n₁·sin θ₁=n₂·sin θ₂, and in the case where the refractive index n, of the material of the SOA 51 is 3.2, then 3.2·sin 7°=1·sin θ₂, because the incidence angle θ₁ with respect to the end face is 7° and the refractive index n₂ of air is 1. Consequently, the emergence angle θ₂ is nearly equal to 22.7°, that is, light is output from the end face of the SOA 51 at the emergence angle 22.7°.

Thus, the light output from the end face of the SOA 51 at the emergence angle 22.7° is input to the optical fiber 52b. Since the SOA 51 is obliquely positioned, lenses 53a and 53b are used to achieve optical coupling between the SOA 51 and the respective optical fibers 52a and 52b. Specifically, the lens 53a optically couples the input-side optical fiber 52a with the SOA 51, and the lens 53b optically couples the output-side optical fiber 52b with the SOA 51.

FIG. 13 also shows a conventional arrangement for optical coupling between the SOA 51 and an optical fiber, wherein spherical lensed fibers 54a and 54b are used in conjunction with the SOA 51, by way of example. The distal end of each of the spherical lensed fibers 54a and 54b is formed into a spherical shape and serves as a lens, and therefore, the lenses 53a and 53b shown in FIG. 12 can be omitted.

As conventional techniques using SOA, a technique has been proposed in which a semiconductor optical amplifier is used in combination with an external resonator constituted by a fiber grating, and the fiber grating has a distal end formed into a spherical shape to be optically coupled with the light emergence end face of the semiconductor optical amplifier coated with a low-reflection film (e.g., Unexamined Japanese Patent Publication No. 2000-236138 (paragraph nos. [0045] to [0054], FIG. 1)).

FIGS. 14 and 15 each illustrate optical coupling between an SOA array and an optical fiber array.

The figures individually show only one side of the arrangement, with an input-side optical fiber array and an input-side lens array omitted. In FIG. 14, an optical fiber array 64, which is an array of optical fibers 64a to 64d, is optically coupled with an SOA array 61, which is an array of SOAs 61a to 61d, through a lens array 62, which is an array of lenses 62a to 62d. In FIG. 15, a spherical lensed fiber array 65, which is an array of spherical lensed fibers 65a to 65d, is optically coupled with the SOA array 61.

In either of the arrangements shown in FIGS. 14 and 15, when optically coupling the SOA array and the optical fiber array, it is necessary that the pitch P1 (distance between the optical waveguides of adjacent SOAs) of the SOA array should be equal to the pitch P2 (distance between the centers of the cores of adjacent optical fibers) of the optical fiber array.

When manufacturing SOA arrays, on the other hand, the pitch P1 of the SOA array should preferably be reduced as small as possible, in order to increase the number of SOAs mounted per unit area and thereby heighten the degree of integration. However, in conventional SOA arrays, SOAs should not be arrayed with a pitch smaller than the diameter of the optical fiber, giving rise to the problem that the degree of integration of SOA arrays cannot be improved.

FIG. 16 illustrates the problem associated with the conventional optical coupling arrangements. In order to mount more SOAs per unit area of a wafer (thin substrate of semiconductor used for the manufacture of IC chips), SOAs need to be arrayed with a narrower pitch.

In the conventional optical coupling arrangements, however, the pitch of the SOA array must be equal to that of the optical fiber array (P1=P2), to achieve optical coupling between the SOA array and the optical fiber array. Thus, as seen from FIG. 16, the narrowest allowable pitch of the SOA array is equal to the pitch with which optical fibers are arrayed in contact with one another, namely, the pitch equal to the diameter of the optical fiber.

Specifically, ordinary optical fibers have a diameter of 125 μm, and therefore, the pitch of the SOA array should be 125 μm at the smallest. Accordingly, even though more SOAs can be mounted on the wafer, the conventional optical coupling arrangements do not permit SOAs to be arrayed with a pitch smaller than 125 μm corresponding to the diameter of optical fibers, posing a problem that the degree of integration of SOA arrays cannot be improved (if the pitch of the SOA array is set smaller than the diameter 125 μm of optical fibers, then the optical coupling between the SOAs and the optical fibers cannot be achieved).

Further, the SOA has a beam spot size (the radius of a light beam passing through the optical waveguide of the SOA) smaller than that of the optical fiber. A problem therefore arises in that the conventional optical coupling arrangements are poor in optical coupling efficiency.

### SUMMARY OF THE INVENTION

The present invention was created in view of the above circumstances, and an object thereof is to provide an optical gate array device which permits SOAs to be arrayed with a pitch smaller than the diameter of optical fibers and which is also improved in optical coupling efficiency.

To achieve the object, there is provided an optical gate array device for controlling optical signals. The optical gate array device comprises an optical gate array having an array of optical gates, an optical fiber array having an array of optical fibers, and a lens arranged between the optical gate array and the optical fiber array, for collectively achieving optical coupling between all of the optical gates of the optical gate array and all of the optical fibers of the optical fiber array.

The above and other objects, features and advantages of the present invention will become apparent from the following description when taken in conjunction with the accompanying drawings which illustrate preferred embodiments of the present invention by way of example.

### BRIEF DESCRIPTION OF THE DRAWINGS

FIG. 1 illustrates the principle of an optical gate array device.

FIG. 2 shows an optical system according to a first embodiment.

FIG. 3 illustrates MFD.

FIG. 4 shows an optical system according to a second embodiment.

FIG. 5 exemplifies the internal arrangement of an SOA array module.

FIG. 6 illustrates optical coupling of the SOA array module.

FIG. 7 exemplifies the internal arrangement of another SOA array module.

FIG. 8 illustrates optical coupling of the SOA array module.

FIG. 9 exemplifies the internal arrangement of still another SOA array module.

FIG. 10 shows the configuration of an SOA switch system.

FIG. 11 shows the configuration of an m×n optical matrix switch.

FIG. 12 shows a conventional arrangement for optical coupling between an SOA and an optical fiber.

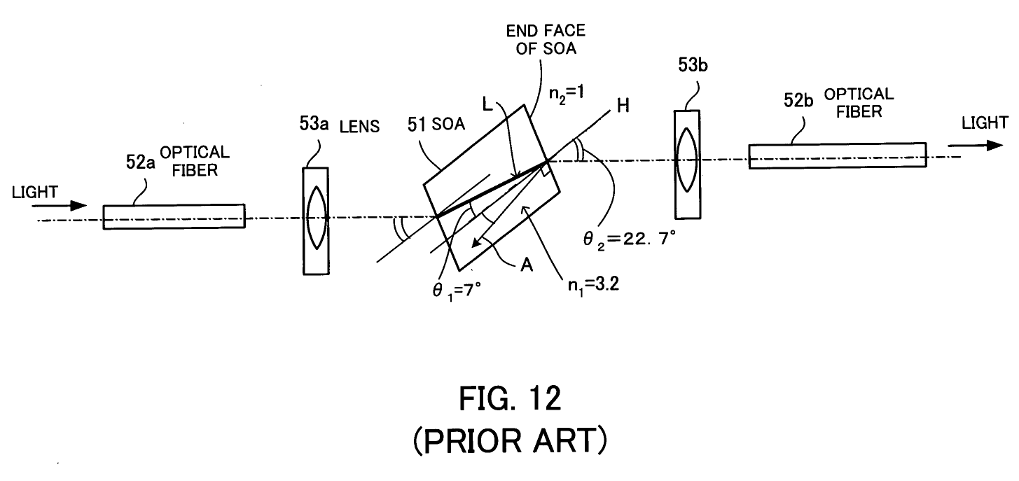

FIG. 13 also shows a conventional arrangement for optical coupling between an SOA and an optical fiber.

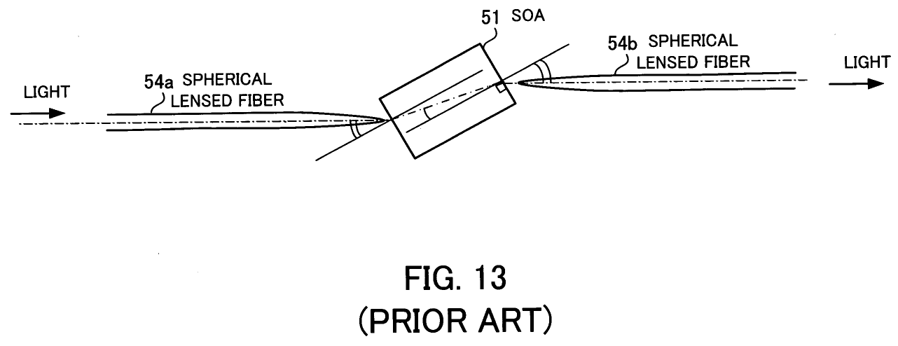

FIG. 14 illustrates optical coupling between an SOA array and an optical fiber array.

FIG. 15 also illustrates optical coupling between an SOA array and an optical fiber array.

FIG. 16 illustrates a problem associated with the conventional optical coupling arrangements.

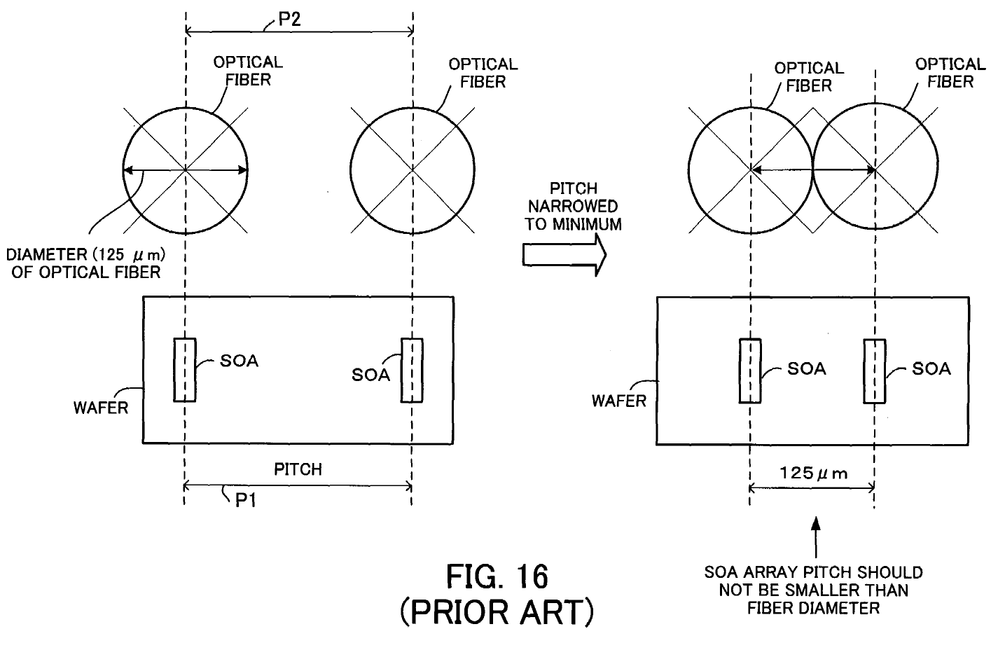

### DESCRIPTION OF THE PREFERRED EMBODIMENTS

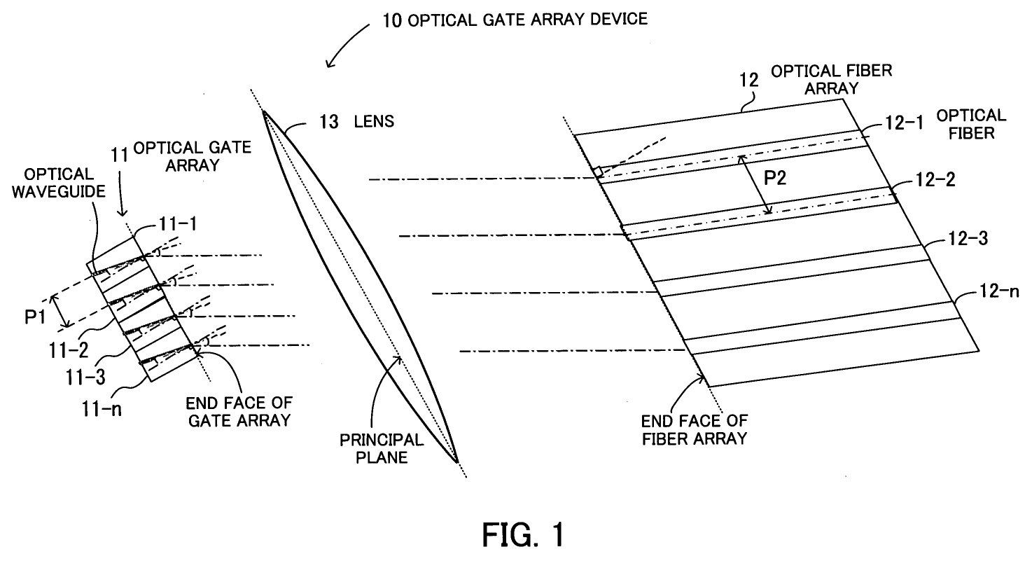

Preferred embodiments of the present invention will be described below with reference to the accompanying drawings, wherein like reference numerals refer to like elements throughout. FIG. 1 illustrates the principle of an optical gate array device. The optical gate array device 10 is a module including an optical gate array 11, an optical fiber array 12 and a lens 13 for controlling optical signals.

The optical gate array 11 is an array of optical gates 11-1 to 11-n, and the optical fiber array 12 is an array of optical fibers 12-1 to 12-n. The lens 13 is a single bulk lens arranged between the optical gate array 11 and the optical fiber array 12.

When optical signals are propagated from the optical gate array 11 to the optical fiber array 12, the lens 13 receives the optical signals emerging from all of the optical gates 11-1 to 11-n of the optical gate array 11, to collectively achieve optical coupling between the optical gates 11-1 to 11-n and the optical fibers 12-1 to 12-n. On the other hand, when optical signals are propagated from the optical fiber array 12 to the optical gate array 11, the lens 13 receives the optical signals emerging from all of the optical fibers 12-1 to 12-n of the optical fiber array 12, to collectively achieve optical coupling between the optical fibers 12-1 to 12-n and the optical gates 11-1 to 11-n.

The lens-side end face of the optical gate array 11, the principal plane (principal flat plane) of the lens 13 and the lens-side end face of the optical fiber array 12 are arranged parallel with each other. Also, the optical fiber array 12 is positioned with the angle of its end face adjusted so that when light emerging from the lens 13 is input to the optical fibers 12-1 to 12-n, the light refracted at the end faces of the optical fibers 12-1 to 12-n may be directed along the centers of the cores of the respective optical fibers 12-1 to 12-n.

In the arrangement shown in FIG. 1, the pitch P1 of the optical gate array 11 and the pitch P2 of the optical fiber array 12 can be so set as to fulfill the relationship P1<P2, thus permitting the optical gates to be arrayed with a pitch smaller than the diameter of the optical fibers.

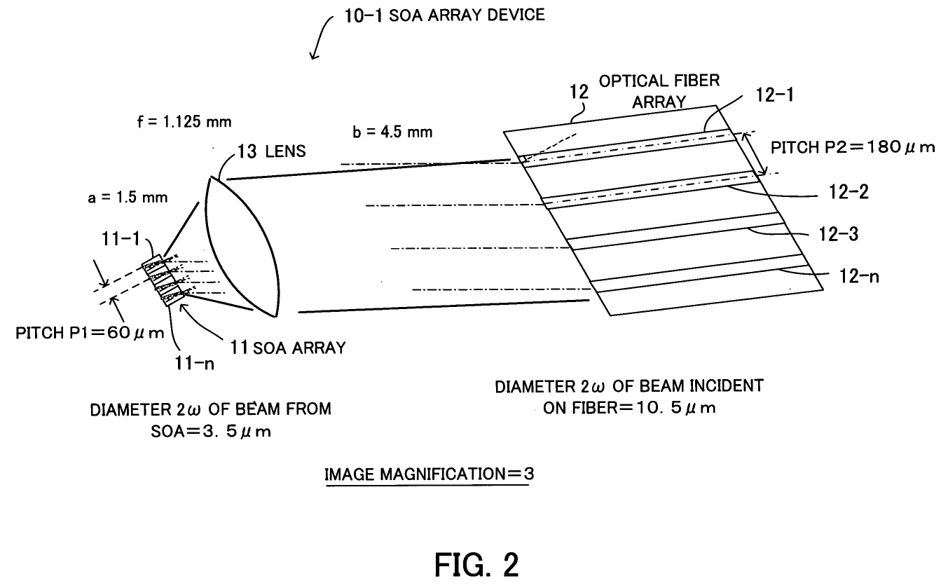

Referring now to specific embodiments, the optical system of the optical gate array device 10 will be explained. In the following, the optical gate will be referred to as SOA. FIG. 2 shows an optical system according to a first embodiment, wherein an SOA array device 10-1 of the first embodiment includes an SOA array 11, the optical fiber array 12, and the lens 13.

The lens 13 receives optical signals from SOAs 11-1 to 11-n of the SOA array 11 and outputs the optical signals therefrom to the optical fiber array 12. At this time, because of the image magnification of the lens 13, the intervals of light beams emerging from the SOAs 11-1 to 11-n are expanded, and also narrow beam spot sizes of the SOAs 11-1 to 11-n are enlarged to broader beam spot sizes of the optical fibers 12-1 to 12-n.

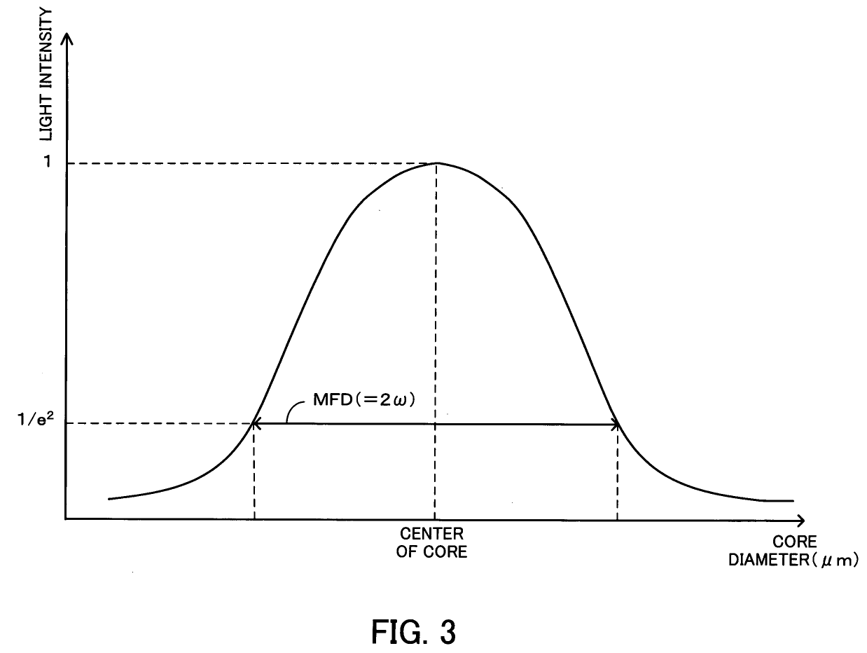

The following explains the design of the first embodiment. The optical fibers 12-1 to 12-n, which are SMFs (Single Mode Fibers), have a beam diameter of 10.5 μm, and it is assumed that the SOAs 11-1 to 11-n have a beam diameter of 3.5 μm. The beam diameter represents a mode field diameter (MFD), and MFD will be briefly explained with reference to FIG. 3.

FIG. 3 illustrates MFD, wherein the vertical axis indicates light. intensity and the horizontal axis indicates core diameter. A light beam emerging from an SOA or an optical fiber is not a parallel beam but a radiant beam that radially spreads. MFD is an index representing the degree of such beam spreading relative to the core diameter. The light intensity distribution can be plotted as a curve similar to a Gaussian distribution, as shown in the figure, wherein the light intensity is highest at the center of the core and gradually decreases toward outer regions of the core.

Provided the maximum light intensity at the center of the core is 1, the MFD is generally defined as a core diameter on the curve where the light intensity is at 1/e² (about 13.5% of the maximum value 1; e is the base (=2.718 . . . ) of the natural logarithm).

Generally, the radius of the core diameter which equals 1/e² is called the beam spot size and expressed as ω, and the core diameter equal to 1/e² is called the MFD (beam diameter) and expressed as 2ω. For wavelengths around 1550 nm, an SMF optical fiber has an MFD of about 10.5 μm.

Reverting to the explanation of the design, the image magnification is set to 3, since the ratio of the beam diameters is 10.5/3.5=3. Assuming that the distance from the end face of the SOA array 11 to the principal plane of the lens 13 is “a” and that the distance from the principal plane of the lens 13 to the end face of the optical fiber array 12 is “b”, the image magnification is equal to b/a. Accordingly, the distances are set as follows: a=1.5 mm and b=4.5 mm (4.5/1.5=3), for example, so that the image magnification may equal 3.

On the other hand, where the pitch P1 of the SOA array 11 is 60 μm, the intervals of light beams emerging from the SOAs 11-1 to 11-n are expanded three times, namely, to 180 μm (=60 μm×3) by the lens 13 because the image magnification is equal to 3. The pitch P2 of the optical fiber array 12 is therefore set to 180 μm.

One of typical parameters that need to be taken into account when selecting the lens 13 is focal distance. Where parallel beams of light are incident on the lens, the focal distance is the distance from the lens to the focal point where the beams emerging from the lens are converged.

Provided the focal distance of the lens 13 is f, the relationship between the distance “a” from the end face of the SOA array 11 to the principal plane of the lens 13 and the distance “b” from the principal plane of the lens 13 to the end face of the optical fiber array 12 can be expressed by the following equation (1):

(1/a)+(1/b)=1/f (1)

In this instance, a=1.5 mm and b=4.5 mm, and therefore, f=1.125 mm. Accordingly, where a=1.5 mm and b=4.5 mm, a lens with a focal distance “f” of 1.125 mm is selected as the lens 13. Conversely, where a lens with a focal distance “f” of 1.125 mm is to be used as the lens 13 and the distance “a” is set to 1.5 mm, for example, the distance “b” (=4.5 mm) can be derived from the equation (1).

In the above explanation of the design, the numerical values are given by way of example only and may alternatively be as follows: Where image magnification =3, a=3 mm and b=9 mm, f is found to be 2.25 from the equation (1), showing that a lens with the focal distance 2.25 mm should be selected as the lens 13.

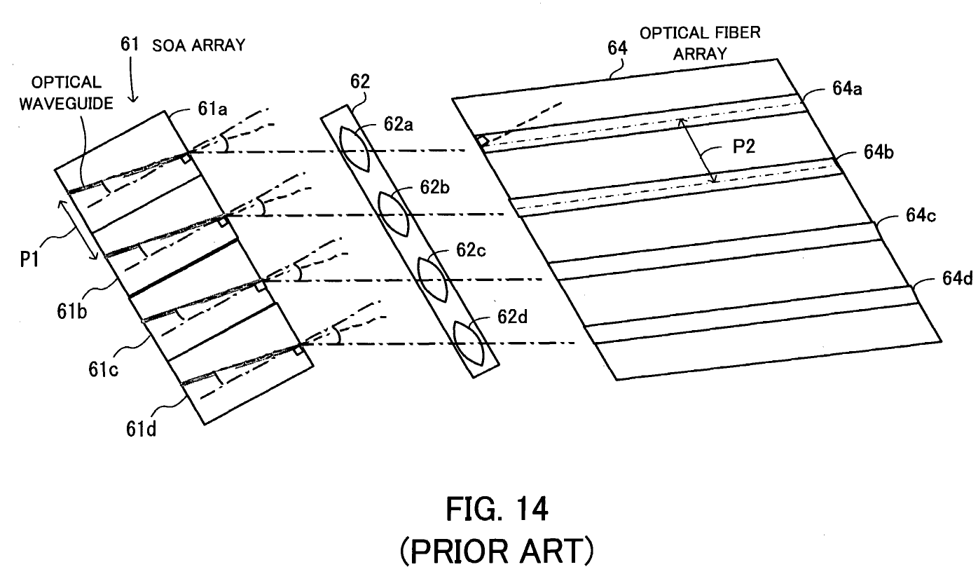

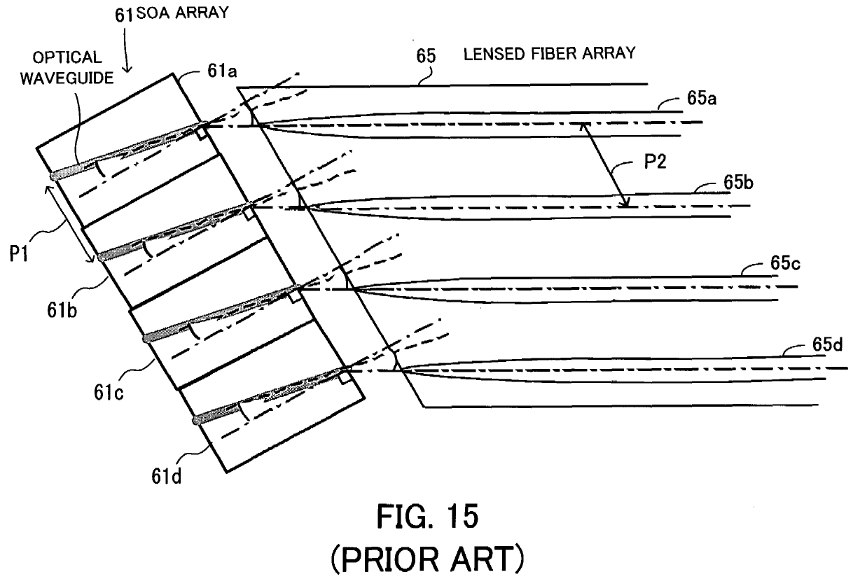

In the conventional arrangements shown in FIGS. 14 and 15, the SOA array and the optical fiber array are optically coupled by using the lens array 62 which includes the lenses 62a to 62d arrayed so as to correspond to the respective SOA chips 61a to 61d of the SOA array 61, or the lensed fiber array 65 which includes the spherical lensed fibers 65a to 65d arrayed so as to correspond to the respective SOA chips 61a to 61d. Consequently, the pitch of the SOA array and the pitch of the optical fiber array must be equal to each other and there is a limit to the narrowest allowable pitch of the SOA array.

In the aforementioned SOA array device 10-1, by contrast, the image magnification of the lens is determined so as to be equal to the ratio of the beam spot size of the optical fibers to that of the SOAs (i.e., the ratio of the beam diameter of the optical fibers to that of the SOAs), and the ratio of the pitch of the optical fiber array to that of the SOA array is set to be equal to the image magnification.

Consequently, the beam spot size 3.5 μm of the SOAs 11-1 to 11-n is enlarged three times so as to be equal to the beam spot size 10.5 μm of the optical fibers 12-1 to 12-n, thus making it possible to improve the optical coupling efficiency.

Also, the pitch (P1) 60 μm of the SOA array 11 is expanded three times to 180 μm on the emergence side of the lens 13, and thus the pitch (P2) of the optical fiber array 12 is set to 180 μm. Namely, unlike the conventional arrangements, it is unnecessary to make the pitch of the SOA array equal to that of the optical fiber array in order to achieve optical coupling between the two arrays. Thus, since the pitch of the SOA array may be smaller than the diameter (125 μm) of the optical fibers, an SOA array with a pitch smaller than the diameter (125 μm) of the optical fibers can be used, making it possible to increase the degree of integration of the optical gate array.

For the lens 13 selected in the above manner, an eccentric lens may be used of which the centers of the convex surfaces are shifted from each other such that, when the lens 13 is obliquely positioned, the centers of the incidence- and emergence-side convex surfaces are at the same level (incident light refracted at the surface of the lens 13 is directed along the center of the lens 13).

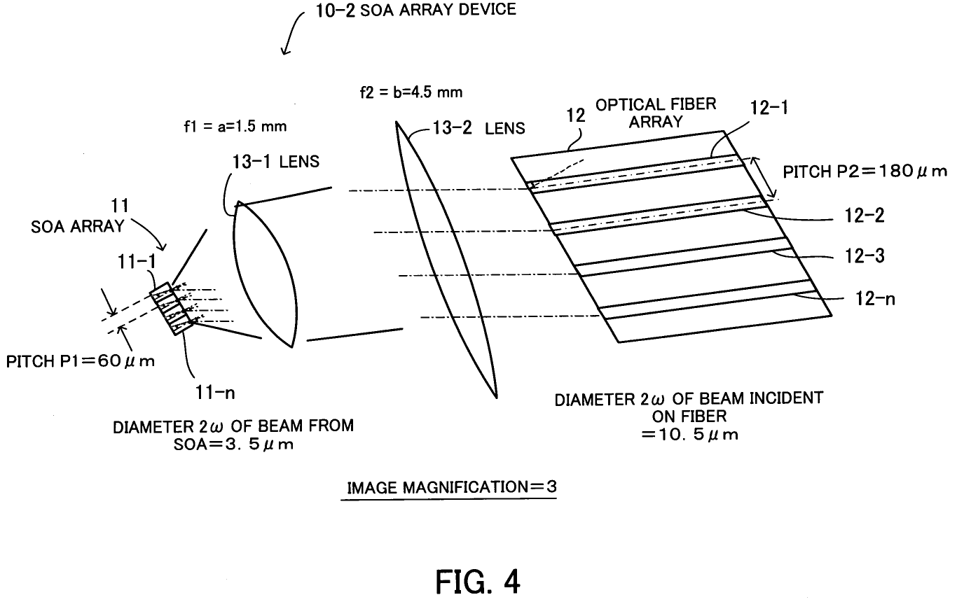

The following explains the design of a second embodiment. FIG. 4 shows an optical system according to the second embodiment. As illustrated, an SOA array device 10-2 of the second embodiment includes a plurality of lenses, namely, a lens 13-1 (first lens) and a lens 13-2 (second lens), arranged between the SOA array 11 and the optical fiber array 12. In this case, the principal planes of the lenses 13-1 and 13-2 and the end faces of the SOA array 11 and optical fiber array 12 are arranged parallel with one another.

It is assumed that the conditions for the design are: the beam diameter of the optical fibers 12-1 to 12-n being 10.5 μm, the beam diameter of the SOAs 11-1 to 11-n being 3.5 μm, image magnification =3, and the pitch of the SOA array 11 being 60 μm, like the first embodiment.

In the second embodiment, the SOA array 11 and the lens 13-1 constitute a confocal system, and the lens 13-2 and the optical fiber array 12 also constitute a confocal system. The term “confocal” signifies a state in which a light source or a light receiver is arranged at the focus of a lens or a state in which two or more lenses are arranged such that their foci coincide with each other. Accordingly, the SOA array 11 is positioned at the focal point of the lens 13-1, and the optical fiber array 12 is positioned at the focal point of the lens 13-2.

The overall image magnification of the lenses 13-1 and 13-2 constituting a confocal system is equal to f2/f1, where f1 is the focal distance of the lens 13-1 and f2 is the focal distance of the lens 13-2. Namely, the distance “a” from the end face of the SOA array 11 to the principal plane of the lens 13-1 is equal to the focal distance “f1” of the lens 13-1, and the distance “b” from the principal plane of the lens 13-2 to the end face of the optical fiber array 12 is equal to the focal distance “f2” of the lens 13-2. The distance between the lenses 13-1 and 13-2 is set to f1+f2. Light emerging from the SOA array 11 arranged at the focal distance “f1” from the lens 13-1 is turned into a parallel beam as it passes through the lens 13-1.

The second embodiment will be summarized with reference to the case where the design image magnification is set to 3. In this case, a lens with a focal distance of 1.5 mm is selected as the lens 13-1, and a lens with a focal distance of 4.5 mm is selected as the lens 13-2. The SOA array 11 is positioned at a distance of 1.5 mm from the principal plane of the lens 13-1, and the optical fiber array 12 is positioned at a distance of 4.5 mm from the principal plane of the lens 13-2.

With this arrangement, the beam spot size 3.5 μm of the SOAs 11-1 to 11-n is enlarged three times so as to be equal to the beam spot size 10.5 μm of the optical fibers 12-1 to 12-n, thus making it possible to improve the optical coupling efficiency. Further, the pitch (P1) 60 μm of the SOA array 11 is expanded three times to 180 μm on the emergence side of the lens 13-2, whereby an SOA array with a pitch smaller than the diameter (125 μm) of the optical fibers can be used.

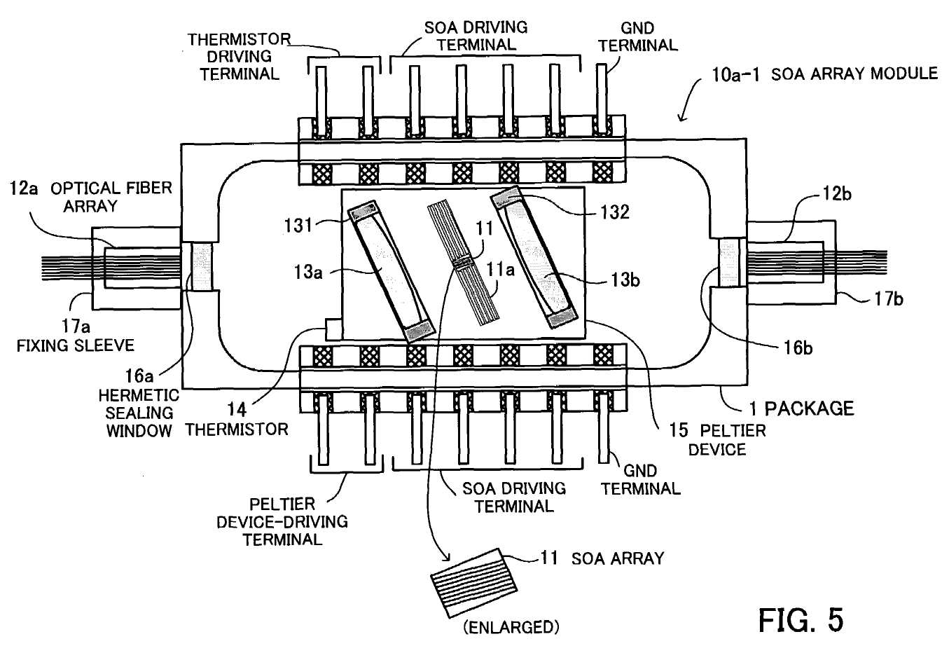

An exemplary internal arrangement of a module into which the SOA array device 10 is packaged will be now described with reference to FIG. 5, wherein the SOA array device 10-1 of the first embodiment is packaged into an SOA array module 10a-1.

A package 1 contains the SOA array 11, an SOA carrier 11a, lenses 13a and 13b, a thermistor 14 and a Peltier device 15, and has hermetic sealing windows 16a and 16b. Optical fiber arrays 12a and 12b are inserted into respective fixing sleeves 17a and 17b and secured to the package 1.

The SOA array 11 includes eight SOAs (i.e., the SOA array module 10a-1 is capable of switching eight channels). Also, the SOA array module 10a-1 has a total of 14 ceramic terminals provided on side walls of the package.

The SOA array 11 is fixed to the SOA carrier 11a by, for example, gold-tin soldering. Each SOA of the SOA array 11 is wire-bonded to a corresponding strip line (not shown) of the SOA carrier 11a. The strip lines of the SOA carrier 11a are wire-bonded to the respective SOA driving terminals. When applied with electrical signals through the SOA driving terminals and GND terminals, the SOA array 11 becomes capable of light amplification.

The thermistor 14 is a device for monitoring the internal temperature of the package 1 and is wire-bonded to the thermistor driving terminals by strip lines. The Peltier device 15, which is a temperature control device for keeping the temperature inside the package 1 at a fixed value in accordance with the result of monitoring by the thermistor 14, is wire-bonded to the Peltier device-driving terminals by strip lines.

The lens 13a is arranged between the optical fiber array 12a and the SOA array 11, and the lens 13b is arranged between the SOA array 11 and the optical fiber array 12b. The lenses 13a and 13b are fitted in respective metal frames 131 and 132 made of stainless steel or the like, and are fixed in position by YAG (yttrium-aluminum-garnet crystal) laser welding or the like after being positioned such that the light emerging from the SOA array 11 is directed properly. After the lenses 13a and 13b are fixed, the optical fiber arrays 12a and 12b are positioned so that all channels may provide a maximum optical output, and then are welded to the package 1. The hermetic sealing windows 16a and 16b, which are made of glass, permit only light to transmit therethrough and prevent moisture and oxygen from entering the package 1.

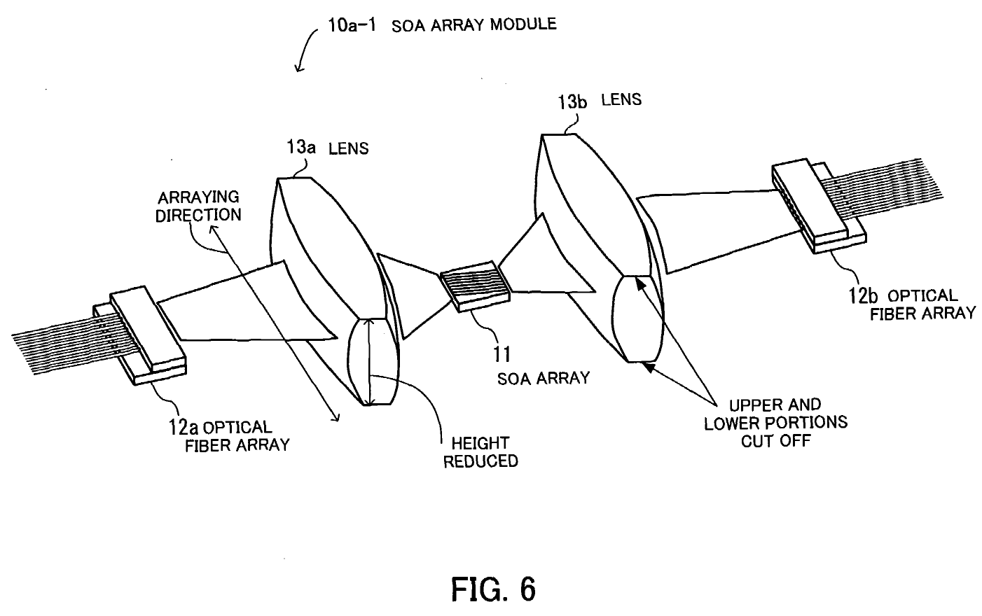

FIG. 6 illustrates the optical coupling of the SOA array module 10a-1. In order to minimize the thickness of the package 1 of the SOA array module 10a-1, the lenses 13a and 13b are each prepared by cutting off upper and lower portions of an ordinary lens, as illustrated, so as to be elongate in the arraying direction.

Thus, the lenses 13a and 13b are each constructed as a cut lens such that each lens is elongate in the arraying direction and has an aperture in the perpendicular direction large enough to admit light to be directed to or radiated from the SOAs. This makes it possible to reduce the height (package thickness) of the SOA array module 10a-1, whereby the size of the module (thickness of the package 1) as well as power consumption can be reduced.

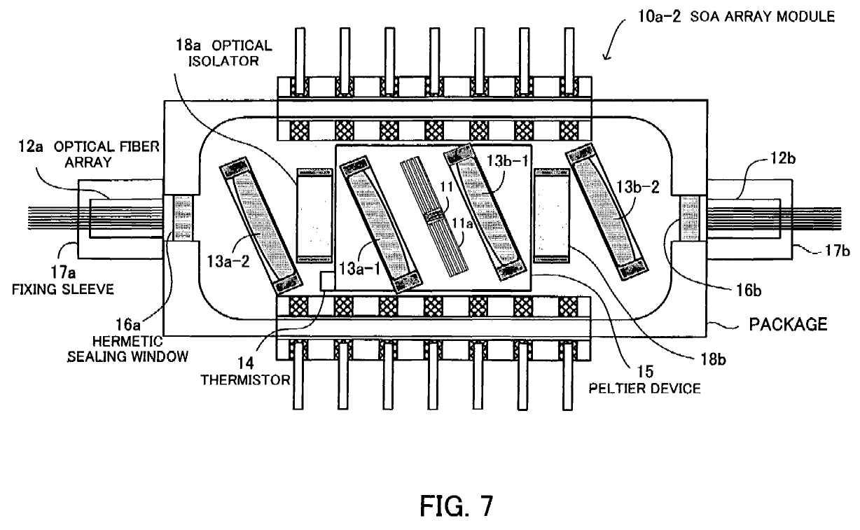

FIG. 7 shows an exemplary internal arrangement of an SOA array module 10a-2 into which the SOA array device 10-2 of the second embodiment is packaged.

The package 1 includes the SOA array 11, the SOA carrier 11a, lenses 13a-1, 13a-2, 13b-1 and 13b-2, the thermistor 14, the Peltier device 15, the hermetic sealing windows 16a and 16b, and optical isolators 18a and 18b. The optical fiber arrays 12a and 12b are inserted into the respective fixing sleeves 17a and 17b and secured to the package 1.

The SOA array module 10a-2 has a construction such that two lenses are arranged on each side of the SOA array to achieve optical coupling. The lenses 13a-1 and 13a-2 are arranged between the optical fiber array 12a and the SOA array 11, and the lenses 13b-1 and 13b-2 are arranged between the SOA array 11 and the optical fiber array 12b.

The optical isolator 18a, which allows light to pass only in the forward direction and shuts off reflected light, is arranged between the lenses 13a-1 and 13a-2, and the optical isolator 18b having the same function is arranged between the lenses 13b-1 and 13b-2. For each of the optical isolators 18a and 18b, an isolator with an aperture capable of passing all of 8-channel light beams is used.

The optical isolators may also be used in the SOA array module 10a-1 shown in FIG. 5 in such a manner that one optical isolator is arranged between the lens 13a and the SOA array 11 while the other between the SOA array 11 and the lens 13b. In other respects, the SOA array module 10a-2 is constructed in the same manner as that shown in FIG. 5, and therefore, no further explanation of the construction is given here.

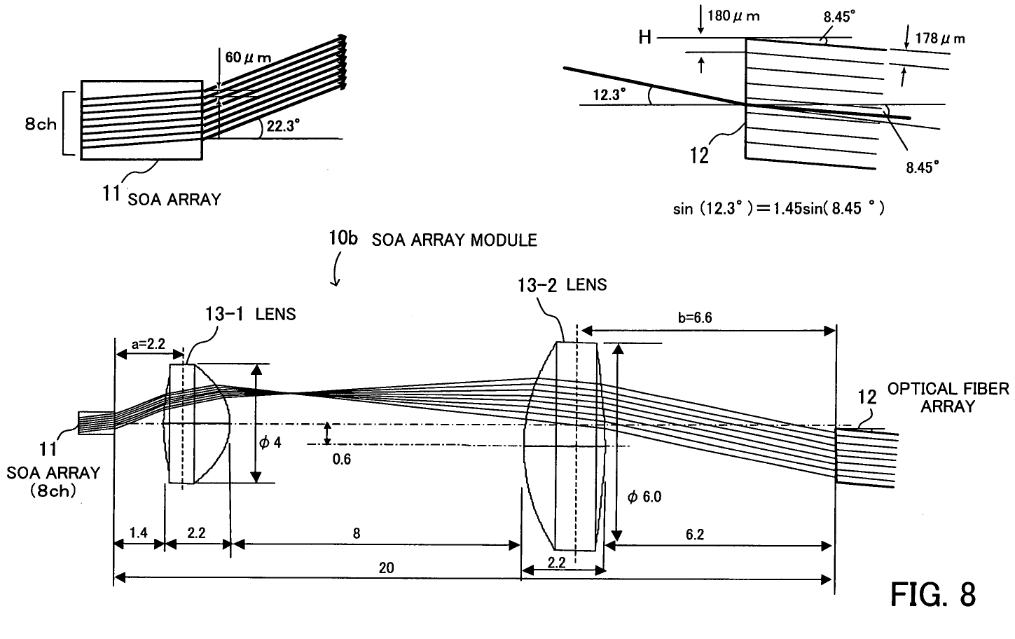

The following describes in detail the manner of how the SOA array module is actually designed. FIG. 8 illustrates optical coupling of an SOA array module 10b. The SOA array module 10b is an optical coupling system having two lenses 13-1 and 13-2 arranged on either side of the SOA array and having an image magnification of 3. In the figure, the numerical values indicate actually calculated dimensions of the embodiment, and the loci of eight beams represent the centers of intensity distributions of the respective beams output from the SOA array 11.

The 8-channel SOA array 11 has eight SOAs arrayed with a pitch of 60 μm, and light emerges obliquely from all SOAs at an emergence angle of 22.3°. The lens 13-1 has a diameter φ of 4 mm and is positioned at a distance of 1.4 mm from the SOA array 11 such the light emerging from the SOA array is incident substantially on one half of the lens.

The lens 13-2 is positioned at a distance of about 8 mm from the lens 13-1 with the center thereof shifted by about 0.6 mm from the center of the lens 13-1. Like the lens 13-1, the lens 13-2 receives light substantially on one half thereof. With this arrangement, the SOA array is optically coupled with the optical fiber array 12 which is positioned at a distance of 6.2 mm from the lens 13-2.

The distance “a” from the end face of the SOA array 11 to the principal plane of the lens 13-1 is 2.2 mm, and the distance “b” from the principal plane of the lens 13-2 to the end face of the optical fiber array 12 is 6.6 mm. Therefore, the image magnification is 6.6/2.2=3.

Thus, in the optical coupling system of the SOA array module 10b, the design image magnification is set to 3, and accordingly, the SOA pitch 60 μm is expanded up to 180 μm on the end face of the optical fiber array 12. Also, the mode size of the SOA is enlarged three times so as to be nearly equal to the mode size of the optical fiber, thus permitting highly efficient optical coupling.

The light falls upon the end face of the optical fiber array 12 obliquely at an incidence angle of 12.3°. Where the refractive index of the optical fiber is 1.45, therefore, the optical fiber array 12 needs to be inclined by θ with respect to the normal H in order for the light to pass through the center of the core of the optical fiber. From Snell's law, 1·sin(12.3°)=1.45·sin θ, and therefore, θ=8.45°. Namely, to cause the light incident obliquely at the incidence angle 12.3° to propagate straight through the optical fiber, the optical fiber array 12 has to be inclined at 8.45° with respect to the normal H.

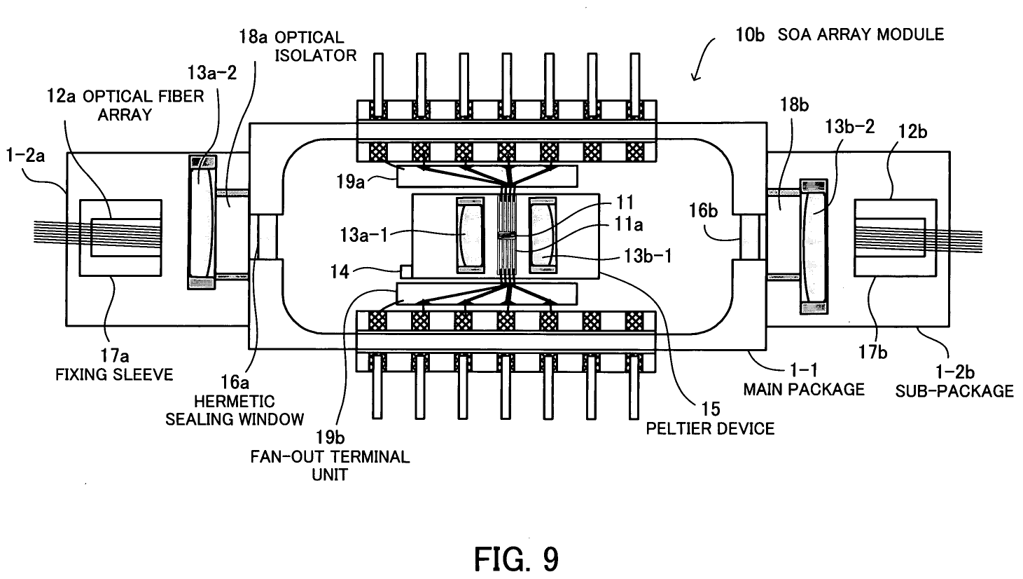

FIG. 9 shows an exemplary internal arrangement of the SOA array module 10b. The SOA array module 10b comprises a main package 1-1 and sub-packages 1-2a and 1-2b.

The main package 1-1 contains the SOA array 11, the SOA carrier 11a, the lenses 13a-1 and 13b-1, the thermistor 14, the Peltier device 15, the hermetic sealing windows 16a and 16b, and fan-out terminal units 19a and 19b.

The pitch of the electrodes of the SOA carrier 11a significantly differs from the pitch of the ceramic terminals of the main package 1-1. Generally, therefore, a fan-out terminal unit is inserted between the SOA carrier 11a and the ceramic terminal array of the main package 1-1 to make up for the pitch difference. FIG. 9 shows the arrangement wherein the fan-out terminal units 19a and 19b are arranged on opposite sides of the SOA carrier 11a and connected thereto by strip lines.

Also, inside the main package 1-1, the lenses (first lenses) 13a-1 and 13b-1 are arranged, together with the Peltier device 15, in the vicinity of the SOA array 11, and these elements are sealed off from the outside by the main package and the hermetic sealing windows 16a and 16b so that the SOA array 11 may not be exposed to moisture or oxygen.

Further, the sub-packages 1-2a and 1-2b are externally attached to the main package 1-1 so as to face the respective hermetic sealing windows 16a and 16b. The sub-package 1-2a includes the optical isolator 18a for shutting off reflected light, the lens (second lens) 13a-2, the optical fiber array 12a and the fixing sleeve 17a, and the sub-package 1-2b includes the optical isolator 18b for shutting off reflected light, the lens (second lens) 13b-2, the optical fiber array 12b and the fixing sleeve 17b. The elements in each sub-package are fixed by YAG laser welding or the like after being properly positioned.

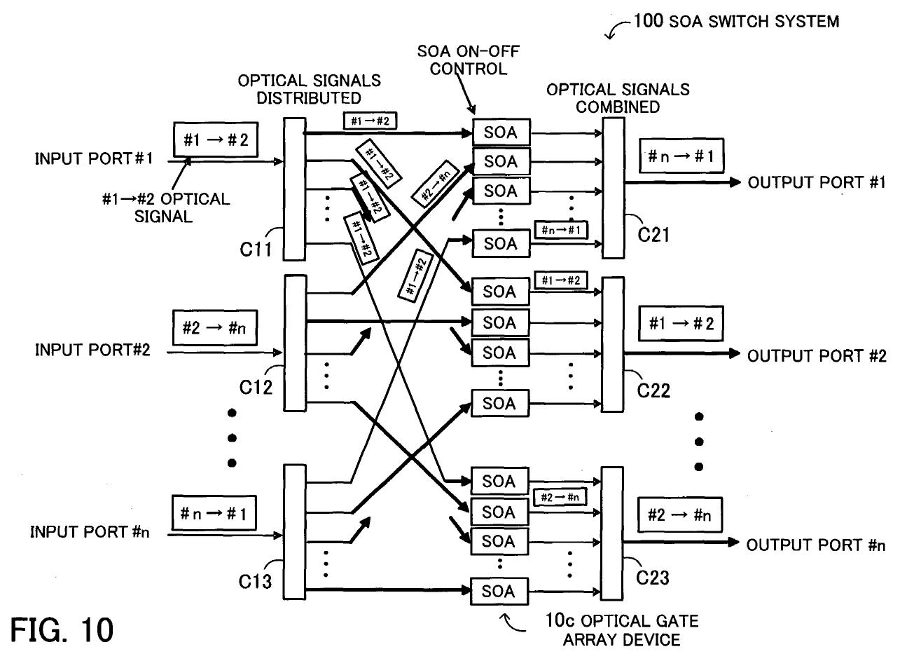

An SOA switch system to which the optical gate array device 10 is applied will be now described. FIG. 10 shows a configuration of such an SOA switch system. The SOA switch system 100 comprises distributing couplers C11 to C13, combining couplers C21 to C23, and an optical gate array device 10c having a plurality of SOAs.

The principle of switching operation will be explained. Optical signals input from the input ports are split by the distributing couplers C11 to C13 into as many optical signals as the input/output ports, and only SOAs associated with desired ports are switched on while the SOAs associated with the other ports are switched off, to allow the outputs from the SOAs to be combined by the combining couplers C21 to C23, whereby only the optical signals from the input ports to be connected are selected (amplified) and connected to the output ports.

In many cases, the number n of optical gates (SOAs) in the optical gate array device 10c is equal to the number n of input/output ports, and generally, n is set to 4 or 8. Where the number n of input/output ports is greater than 8, however, the number of input/output ports is often different from the number of optical gates in the optical gate array device 10c, and in such cases, the number of optical gates in the optical gate array device 10c is set so that the number of input/output ports may be an integer multiple of the number of optical gates.

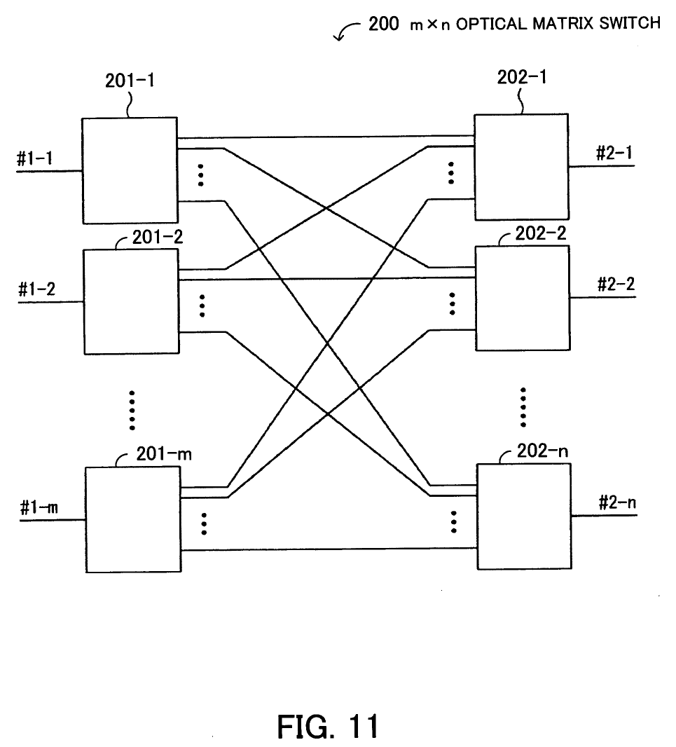

FIG. 11 shows the configuration of an m×n optical matrix switch. In the figure, an m×n optical matrix switch 200 with m input ports (#1-1 to #1-m) and n output ports (#2-1 to #2-n) is configured using the SOA switch system 100.

The m×n optical matrix switch 200 comprises 1×n optical distributors 201-1 to 201-m, which are m in number and each adapted to receive a light beam from a corresponding one of the m input ports and split the light beam into n corresponding in number to the n output ports, and m×1 optical combiners 202-1 to 202-n, which are n in number and each adapted to combine the m light beams from the m optical distributors 201-1 to 201-m and output the combined light beam to a corresponding one of the n output ports.

The SOA switch system 100 shown in FIG. 10 may be used for either or both of the set of m optical distributors 201-1 to 201-m and the set of n optical combiners 202-1 to 202-n, to construct the m×n optical matrix switch 200.

As described above, the SOA array device 10 of the present invention has a construction such that the lens 13 is arranged between the SOA array 11 and the optical fiber array 12 to collectively achieve optical coupling between all SOAs of the SOA array 11 and all optical fibers of the optical fiber array 12.

This permits the SOA array 11 to be fabricated with an increased number of SOAs formed per unit area of the wafer, so that the SOA pitch can be reduced to a value smaller than the diameter 125 μm of the optical fiber, for example, to 80 μm or 50 μm. Further, the beam spot size of the SOA is enlarged so as to be equal to that of the optical fiber, thus making it possible to improve the optical coupling efficiency.

In the optical gate array device of the present invention, the lens is arranged between the optical gate array and the optical fiber array to collectively achieve optical coupling between all optical gates of the optical gate array and all optical fibers of the optical fiber array. This permits the use of an optical gate array with a pitch smaller than the diameter of the optical fiber, making it possible to increase the degree of integration of the optical gate array. Further, the beam spot size of the optical gate is enlarged so as to be equal to that of the optical fiber, and accordingly, the optical coupling efficiency can be improved.

The foregoing is considered as illustrative only of the principles of the present invention. Further, since numerous modifications and changes will readily occur to those skilled in the art, it is not desired to limit the invention to the exact construction and applications shown and described, and accordingly, all suitable modifications and equivalents may be regarded as falling within the scope of the invention in the appended claims and their equivalents.

What is claimed is:

1. An optical gate array device for controlling optical signals, comprising:
an optical gate array having an array of optical gates;
an optical fiber array having an array of optical fibers; and
a lens arranged between the optical gate array and the optical fiber array, for collectively achieving optical coupling between all of the optical gates of the optical gate array and all of the optical fibers of the optical fiber array.

2. The optical gate array device according to claim 1, wherein an end face of the optical gate array, a principal plane of the lens and an end face of the optical fiber array are arranged in parallel to one another.

3. The optical gate array device according to claim 1, wherein the lens has an image magnification so determined as to be equal to the ratio of a beam spot size of the optical fibers to a beam spot size of the optical gates, and the ratio of a pitch of the optical fiber array to a pitch of the optical gate array is set so as to be equal to the image magnification.

4. The optical gate array device according to claim 3, wherein, provided that the image magnification, which is so determined as to be equal to the ratio of the beam spot size of the optical fibers to that of the optical gates, is equal to b/a, the optical gate array is positioned at a distance “a” from the lens, the optical fiber array is positioned at a distance “b” from the lens, and the lens has a focal distance “f” satisfying (1/a)+(1/b)=(1/f).

5. The optical gate array device according to claim 3, wherein the lens includes a first lens and a second lens, and
provided that the first and second lenses have focal distances f1 and f2, respectively, the optical gate array and the first lens constitute a confocal system with the optical gate array positioned at the focal distance “f1” from the first lens, the second lens and the optical fiber array constitute a confocal system with the optical fiber array positioned at the focal distance “f2” from the second lens, and the image magnification, which is so determined as to be equal to the ratio of the beam spot size of the optical fibers to that of the optical gates, is equal to f2/f1.

6. The optical gate array device according to claim 5, wherein the first and second lenses are positioned such that centers thereof are not aligned with each other but separate from each other.

7. The optical gate array device according to claim 1, further comprising an optical isolator arranged between the optical gate array and the optical fiber array and having an aperture large enough to admit all light beams emerging from the optical gate array.

8. The optical gate array device according to claim 1, wherein the lens comprises a cut lens which is cut in a manner such that the lens is elongate in an arraying direction of the optical gate array and the optical fiber array and has an aperture in a perpendicular direction large enough to admit light radiated from the optical gate array.

9. The optical gate array device according to claim 1, wherein the lens has a center aligned with a center of the optical gate array in an arraying direction thereof so that light beams emerging from the optical gates may pass through one half of the lens.
